(19) United States
(12) Patent Application Publication
(10) Pub. No.: US 2022/0292319 A1
(43) Pub. Date: Sep. 15, 2022

(54) PRINT AGENT COVERAGE VECTORS

(71) Applicant: HEWLETT-PACKARD DEVELOPMENT COMPANY, L.P., SPRING, TX (US)

(72) Inventors: Sergio Etchebehere Juan, Sant Cugat del Valles (ES); Peter Morovic, Sant Cugat del Valles (ES); Jan Morovic, London (GB)

(73) Assignee: HEWLETT-PACKARD DEVELOPMENT COMPANY, L.P., SPRING, TX (US)

(21) Appl. No.: 17/634,651

(22) PCT Filed: Sep. 23, 2019
(86) PCT No.: PCT/US2019/052434

§ 371 Date: Feb. 11, 2022

(51) Int. Cl. G06K 15/02

(52) U.S. Cl. CPC G06K 15/1823

(57) ABSTRACT

In an example, a method includes determining, using processing circuitry, a first and second set of print agent coverage vectors characterising a white to black neutral axis in a color space. The first set of print agent coverage vectors may comprise non-black colorant elements and no black colorant elements, and the second set of print agent coverage vectors may comprise black colorant elements and no non-black colorant elements. Print agent coverage vectors characterising a skeleton of a color gamut using the non-black colorants and no black colorants and including the first set of print agent coverage vectors may also be determined, and a third set of print agent coverage vectors may be determined from the print agent coverage vectors characterising the skeleton using interpolation. A fourth set of print agent coverage vectors may be determined from the third set of print agent coverage vectors by, for each of a plurality of vectors of the third set, determining an amount of each non-black colorant specified in the vector of the third set of print agent coverage vectors, determining an amount of black colorant from one of the vectors from the second set of print agent coverage vectors; and determining a vector of the fourth set of print agent coverage vectors based on the amounts of non-black and black colorants.

### BACKGROUND

Printing systems may convert input data (for example, data representing an image for two-dimensional printing, or data representing an object for three dimensional printing) to print instructions, which specify where print materials (for example, colorants such as inks or toners or other printable materials) are to be placed in a print operation.

### BRIEF DESCRIPTION OF DRAWINGS

Examples are now described with reference to the accompanying drawings in which:

FIG. 1 is an example method for determining a set of print agent coverage vectors for a color mapping resource;

FIG. 2A-D are schematic representations of some of the aspects described in FIG. 1;

FIGS. 3 and 4 are example methods for use in determining a color mapping resource;

FIG. 5 is an example of processing circuitry;

FIG. 6 is an example print apparatus; and

FIG. 7 is a block diagram of an example non-transitory machine readable medium associated with a processor.

### DETAILED DESCRIPTION

In the case of two-dimensional printing, a print addressable location may be represented by at least one pixel, and each print addressable location may be printed with at least one colorant such as inks (for example cyan, magenta, yellow and black inks), coatings or other print materials, as well as combinations of those print materials.

In the case of three-dimensional printing, which is also referred to as additive manufacturing, three-dimensional space may be characterised in terms of ‘voxels’, i.e. three-dimensional pixels, wherein each voxel occupies or represents a discrete volume. In examples of three-dimensional printing therefore, an addressable area may correspond to at least one voxel and each voxel may be ‘printed’ i.e. generated or manufactured, using one or a combination of agents and/or build materials.

To briefly discuss three-dimensional printing in greater detail, objects generated by an additive manufacturing process may be formed in a layer-by-layer manner. In one example, an object is generated by solidifying portions of layers of build material. In examples, the build material may be in the form of a powder or powder-like material, or may be a fluid or a sheet material. In some examples, the intended solidification and/or physical properties may be achieved by printing an agent onto a layer of build material. Energy may be applied to the layer and the build material on which an agent has been applied may coalesce and solidify upon cooling. In other examples, directed energy may be used to selectively cause coalescence of build material, or chemical binding agents may be used to solidify a build material. In other examples, three-dimensional objects may be generated by using extruded plastics or sprayed materials as build materials, which solidify to form an object. Objects may be colored during object generation, and/or may be colored in a post processing step.

In examples herein, possible print materials to be applied to an addressable location are specified within an element set, referred to as a vector. In some examples, the print materials may be identified explicitly, i.e. in a set of elements comprising a set of print materials and/or print material combinations. In other examples, it may be that at least one of the elements of an element set relates to another quality, which may in turn be related to print materials. For example, an element may specify a property or the like which can be mapped to print materials. In another example, the elements may be specified in terms of Neugebauer Primaries (a set of the print agents and print agent combinations (and in some examples, the number of drops of printing agent) which can be applied by a particular print apparatus).

In some examples, a set of elements is expressed as a print material coverage vector which defines print material data, for example detailing (explicitly or implicitly, for example via a mapping) the amount of print materials (such as a colorant or coating for two dimensional printing or an agent(s) to be deposited onto a layer of build material, or in some examples, build materials themselves for three dimensional printing), and, if applicable, their combinations.

For example, a print addressable location within input data (e.g. a pixel in image data or a voxel in object model data) may be associated with a vector including an element set. The element set(s) include elements which specify (directly or via a mapping) print materials and print material combinations which may be applied to the location, each element being associated with a probability of being applied to that location. In the case of two-dimensional printing, these may be referred to as area coverage vectors and/or, when the set of elements comprise the Neugebauer Primaries (NPs), as Neugebauer Primary Area Coverage vectors (NPac vectors, or simply NPacs herein). The possible NPs are all the possible states for a single pixel/voxels for a printing system having a set of print agents. For example, for a binary (bi-level) printer, an NP is one of 2^{k} combinations of k print agents within the printing system, wherein print agents can be represented in single-drop states, in a k-dimensional color space. More generally, there may be k combinations for a set of n print agents have K drop states, which may define all of the possible print agent configuration states that a single pixel can receive, and therefore there may be kⁿ NPs.

In the case of three-dimensional printing, such vectors may be referred to as volume coverage vectors, Material Volume coverage vectors (also termed Mvoc vectors, or simply MVocs, herein), which may also specify possible print agents and the combinations of print agents in an element set equivalent to NPacs, may be defined.

As noted above, such vectors provide a probability that a print material or a combination of print materials may be applied in a location. In a simple case, a vector may indicate that the particular print material or print material combination should be applied to that location on X % of occasions, whereas on (100−X) % of occasions the location should be left clear of the print material. In use, a selection of an element of the element set may be resolved at the addressable resolution for the print material and/or printing device. Therefore, if there are N addressable locations in an XY plane associated with such a vector, around X % of these N locations may be expected to receive a print material, while around (100−X) % do not. This region of the XY plane may be intended to be perceived as a color associated with the vector.

For example, in a printing system with two available print materials (for example, inks, coatings or agents), identified as M1 and M2, where each print material may be independently deposited in a print addressable location (e.g. voxel or pixel) as a single drop, there may be 2² (i.e. four) probabilities in a given Mvoc or NPac coverage vector: a first probability for M1 without M2; a second probability for M2 without M1; a third probability for an over-deposit (i.e. a combination) of M1 and M2, e.g. M2 deposited over M1 or vice versa; and a fourth probability for an absence of both M1 and M2 (indicated as Z herein). In this example, it is assumed that a drop of print material may be applied or not: i.e. a binary choice may be made and the value for each agent may be either 0 or 1. The full set of NPs of the printing system are therefore M1, M2, M1M2 and Z.

In this case, a print coverage vector or element set may be: [M1:P1, M2:P2, M1M2:P3, Z:P4] or with example probabilities [M1:0.2, M2:0.2, M1M2:0.5, Z:0.1]—in a set of print addressable locations (e.g. and [x, y] or an [x, y, z] location (which in some examples may be a [x, y] location in a z slice)) to which the element set applies, and on average, 20% of locations are to receive M1 without M2, 20% are to receive M2 without M1, 50% are to receive M1 and M2 and 10% are to be left clear (Z). In non-binary systems, there may be more elements defined describing the different amounts of print agent and/or associated combinations of print agents, which may be applied. As each value is a proportion and the set of values represent the full set of available material combinations, the set of probability values in each element set generally sum to 1 or 100%. Where the probability associated with an NP is zero, then that NP may be (effectively or actually) absent from the vector.

In summary then, an NPac/MVoc describes area coverages for a plurality of NPs of print agent set, and comprises probabilities for elements including up to all the NPs. This NPac or MVoc type of vector may be compared to another example of a vector in which the area/volume coverage is controlled but the ‘at pixel’ or ‘at voxel’ choices are not (“print agent vectors” herein). For example, such a print agent vector may specify that X % of a region receives agent M1 and Y % receives agent M2, but the overprinting of agents is not explicitly defined (although the sum of X and Y may be greater than 100, so overprinting may result).

Print agent coverage vectors may therefore specify a plurality of elements which are related to print materials and to explicit combinations thereof, and a probability for each element. Determining mappings from color space to print agent coverage vectors can present a processing challenge: determining a full set of mappings may consume significant processing resources and large amounts of memory to store.

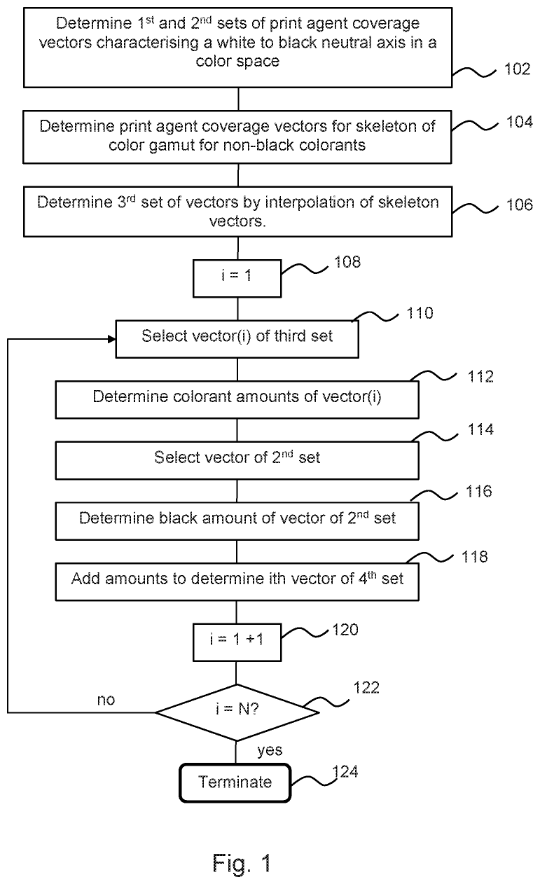

FIG. 1 is an example of a method, which may be a computer implemented method for use in determining a color mapping resource.

The method comprises, in block 102, determining, using processing circuitry, a first and second set of print agent coverage vectors (e.g. NPacs or Mvocs) characterising a white to black neutral axis in a color space. The first set of print agent coverage vectors comprises non-black colorant elements and no black colorant elements, and the second set of print agent coverage vectors comprises black colorant elements and no non-black colorant elements. In other words, the first set includes vectors having elements which specify non-black colorants (and no elements which specify or include black colorants) and the second set includes vectors having elements which specify black colorants (and no elements which specify or include non-black colorants). In some examples, the first and second sets of print agent coverage vectors are determined such that the vectors of each set are evenly spaced from one another, for example being evenly spaced in lightness (L*). The number of vectors in the first set and/or second set may be predetermined.

The color space may be a color space associated with a printing system, for example based on the available colorants, the number of drops of the colorants which may be placed at a print addressable location, and in some example the print media to be used. This information may allow the NPs of the system to be determined.

For example, the print agent coverage vectors may specify a probability of printing a particular color or combination of colors from a print agent set comprising Cyan, Magenta, Yellow and Black print agents (a CMYK color set), or a print agent set comprising, in addition, light Cyan and Magenta print agents (a CcMmYK color set). However, in such an example, the vectors of the first set would characterise the neutral axis using elements specifying agents and combinations of the CMY, or the CcMmY, print agents and not including the K print agent, and the vectors of the second set would characterise the neutral axis using elements specifying the black K colorant only. Black colorants may comprise grey colorants in some examples. These vectors may be specified as an NPac or Mvoc, for example comprising elements specifying individual print agents and combinations of or print agents, each associated with a probability.

In some examples, to determine the vectors of the first and/or second set, candidate print agent coverage vectors may be determined, with any applicable print agent conditions (e.g. the maximum number of drops which may be applied to a print addressable location), for example randomly, using linear programing techniques as discussed in greater detail below, or in some other way, and test patches may be printed based on the vectors. The colorimetry of the test patches may be measured and used to select appropriate vectors which lie on the black to white neutral axis, where ‘white’ is the lightest color that may be produced (which may be a blank media), and ‘black’ is the darkest color.

It will be noted that, in this example, the white to black axis is characterised twice, once using just the black elements (e.g. black NPs), and once using non-black elements (e.g. non-black NPs).

Block 104 comprises determining, using processing circuitry, print agent coverage vectors characterising a skeleton of a color gamut using the non-black colorants and no black colorants and including the first set of print agent coverage vectors.

This skeleton may for example comprise a skeleton of a CMY color cube, wherein each of the vertices of the cube (i.e. the maximum C value, M value and Y value) are populated, as are the combinations relating to the maximum amounts of each colorant, bearing in mind any agent maximum amounts. For example, the maximum amount of each print agent, or the combined agents may be a system maximum (for example, the maximum amount of ink which may be applied to a print media given ink/media characteristics, ink delivery rates and the like) or may be used defined. For example, a user may decide to stay below theoretical system maximum amounts for light inks “c” or “m”, as C and M inks could provide such colorimetries.

In addition, defining the skeleton may comprise determining a number of ‘nodes’ and associated vectors to be defined on each axis (i.e. the number of graduations in color space) and/or defining the skeleton may comprise populating the ‘diagonal’ of each face of the color cube, linking the vertices. The ‘diagonal’ set of vectors may be determined by printing samples of ‘candidate’ vectors (which may be determined to have colorant amounts based on interpolation of the maximum amounts, and elements intended to provide the colorant amounts) and selecting the vectors which fall on the diagonal. This process may be intended to find vectors which provide evenly spaced colors along the axes within the color space and/or which exhibit intended print characteristics. Examples of selection between alternative print agent coverage vectors for given print agent amounts are discussed in greater detail below.

Selecting a vector of the candidate vectors may for example comprise determining colorimetries provided by the print agent coverage vectors. The colorimetry of a coverage vector may for example be modelled or predicted, for example by simulating an image printed using the print coverage vector or use of models for a printing system, and/or the colorimetry of at least one coverage vector may be measured from printed test samples produced using the print agents in the proportions specified in the print agent coverage vector. These methods may be used together, for example with modelling being used to filter out candidate vectors which are unlikely to be included in the skeleton, and printing and measurement used to verify a promising remaining subset of vectors.

While in some examples, the colorimetry may be expressed in the color space of the print agents used (e.g. CMY color space), the colorimetry may, or may also, be expressed in another color space, and may in some examples be a color space which is independent of any print apparatus. For example, the device independent color space may be sRGB, Adobe RGB, or may be some other color space, for example a color space which uses an International Commission on Illumination (CIE) color model. Other color space models include Hue-Saturation-Value (HSV), Hue-Saturation-Lightness (HSL), Yule-Nielsen-corrected XYZ, XYZ, LAB or the like.

The colorimetry (for example in the print agent color space) may be associated with a vector via a lookup table such that, when a color having a specified colorimetry is to be printed, the associated vector is selected for reproducing that color.

Block 106 comprises determining, using processing circuitry, a third set of print agent coverage vectors from the skeleton using interpolation. This effectively populates the CMY cube, but instead of using sample patches, combinations of the vectors used to characterise the skeleton (as well as the vectors of the skeleton) are used. The number of nodes/vectors in the populated cube may depend on the number of nodes on each axis. For example, if each axis has nine graduations/nodes, there may be 9³ nodes/vectors in the populated cube.

One feature of such vectors (i.e. NPacs or Mvocs) is that weighted combinations thereof generally behave linearly in color space. For example, a vector may be associated with a ‘node’ of the color space by linearly combining other vectors with a weighting that decreases as the distance from that node increases. For example, a node A which is central positioned between three other nodes B, C and D may be associated with a vector determined as

$$\frac{1}{3} B + \frac{1}{3} C + \frac{1}{3} D .$$

This linear behaviour is not always exhibited for print agent vectors, which can produce unexpected colorimetries when combined in this way. Therefore, using NPacs or MVocs may allow a lookup table to be populated with vectors by interpolation from a relatively sparse skeleton, as described above, with a high likelihood that the colors associated with the vectors will be as intended.

Thus, in some examples, while the vectors of the skeleton may be evaluated (for example printed) and selected based on that evaluation, a similar level of evaluation may not be carried out for the interpolated vectors. However, in some examples, smoothing and/or optimisation may be carried out, to result in a final third set of print agent coverage vectors which are well dispersed in the color space. For example, smoothing may comprise averaging vectors within a neighbourhood computationally.

The evaluation may comprise determining characteristics of samples printed or modelled using each print agent coverage vector. For example, the characteristic may be a predicted print characteristic such as print agent use, grain, robustness (i.e. repeatability/consistency). In some examples, a plurality of such characteristics may be considered, in some examples with a priority order. The characteristic(s) may for example be modelled or predicted, for example by simulating a sample printed using the print coverage vector. This may comprise subjecting a vector to a halftoning process and generating a simulation of a printed result, which may also include a modelling of any perturbation which may be expected during print operations. In other examples, the characteristic(s) may be determined based on test data from previously printed samples produced using the print agent coverage vector.

Blocks 108 to 124 describe a process of determining, using processing circuitry, a fourth set of print agent coverage vectors from the third set of print agent coverage vectors, which in this example comprises N vectors.

In block 108, an index i is set to 1 and in block 110. the ith vector of the third set of vectors is selected. Therefore, in the first iteration of the method, the first vector is selected.

In block 112, the amount of each non-black colorant specified in the ith vector is determined. This may for example comprise determining the average number of drops of each colorant which will be applied to a print addressable location. For example, for a vector of the form [Z: 0.1, C:0.1, CC: 0.2, MM:0.6], where CC and MM indicate that two drops of the C or M colorant are to be applied (and assuming in this example that the drop sizes are the same for the colorants, which need not be the case), there is a 60% chance that two drops of Magenta will be applied to a location, a 10% chance that 1 drop of Cyan will be applied to a location, a 20% chance that two drops of Cyan will be applied to a location and a 10% chance that no drops will be applied to a location. Therefore, the corresponding print agent vector is Cyan: 50%, Magenta: 120%, and the colorant amounts may be 0.5 for Cyan and 1.2 for magenta. In other examples, average drops per unit area or the like may be determined.

In block 114, a vector of the second set of vectors (i.e. the set of print agent coverage vectors which comprise black colorant elements and no non-black colorant characterising the neutral axis) is selected. In block 116, an amount of black colorant from the second set of print agent coverage vectors is determined in the same way as described above for the ith vector. For example, if the vector is [Z:0.5, K:0.1, KK:0.4], then the corresponding print agent vector is Black:90%, and the colorant amount may be 0.9.

In block 118. an ith vector of a fourth set of vectors is determined by adding the amounts of each colorant to the amount of black. This may be a print agent vector. For example, using the above example, the print agent vector Cyan:50%, Magenta: 120% and Black:90%.

However, in other examples, as will be set out in greater detail below, the amounts may be converted into a print agent coverage vector wherein the elements specify discreet NPs with associated probabilities. There are a range of print agent coverage vectors (e.g. NPacs/Mvocs) which may match the coverage of the print agent vector supplied, and the ‘best’ or selected NPac/Mvoc may be determined based on, for example, any or any combination of intended use case, user preferences, print materials, and the like. In some examples, candidate print agent coverage vectors may be generated, for example, randomly or deterministically using linear programming rules to match the print agent vector coverages. Linear programing may derive candidate vectors following any or any combination of predetermined rules (for example, rules favouring high or low drop states, rules favouring high or low probabilities associated with blank media, and the like). The output of such vectors may be assessed by modelling, by simulation and evaluation, by printing and evaluating test patches, or the like.

In block 120, i is incremented and if it is determined in block 122 that i is greater than N, then the method terminates (block 124). Otherwise, the method loops back to block 110 with a new value of i, and a new vector of the non-black color gamut is selected.

In some examples, another loop may be instigated such that each vector of the second set of vectors is combined with at least some of the vectors of the first set of vectors. In other words, block 108-124 may be repeated for up to each of the vectors from the second set, so each vector of the third set may be combined with any or each vector of the second set, resulting in a set of size N_2×N_3, where N_2 is the number of points in the second set and N_3 is the number of vectors in the third set. However, every combination may not be determined in all examples. For example as black levels reach a maximum, there may be little color difference between adjacent nodes/vectors. Therefore, a selected subset of the third set of vectors may be combined with ‘darker’ vectors of the second set of vectors. Such a method may in effect create nested CMY+K cubes, wherein the K values are selected from the black to white neutral axis.

This may be used to generate a print agent color space to print agent coverage vector mapping resource, wherein each of the fourth set of vectors may be associated with a colorimetry of the third set of vectors and a black level of the selected one of the second set of vectors. For example, if the colorimetry of the third set of vectors is evaluated as a CMY color, then the colorimetry of a vector of the fourth set of vectors may be the CMY value of the third set of vectors on which it is based and the K value from the second vector on which it is based. In other words, assuming each of the C, M, Y and K values are described using a single byte (and so take values between 0 and 255), the CMYK values may be determined based on the number of graduations in color space. For example, there may be 9 points on of the CMY axis in the third color set, so each of the CMY values may be taken from a value set [0, 31, 63, 95, 127, 159, 191, 223, 255]. There may be 9 vectors in the second set of vectors, providing the same potential value set for K. the CMKY values may have A print agent vector of Cyan:50%, Magenta: 120% and Black:90% may for example be associated with CMY values of [63, 191, 0] and a K value of 95, therefore having CMYK=[63, 191, 0, 95] (as an example)

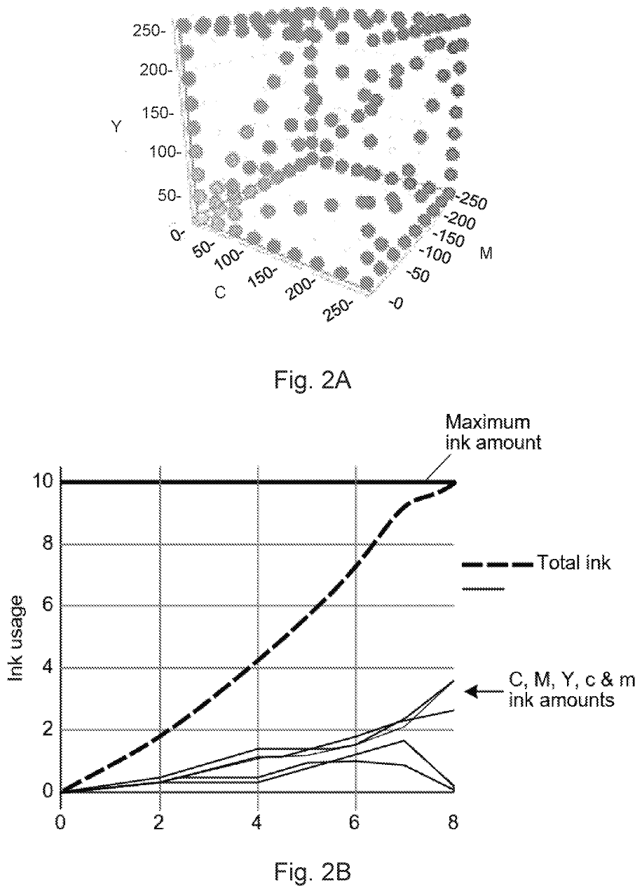

The method is illustrated schematically in FIG. 2A-D.

FIG. 2A shows a CMY skeleton created for a particular set of colorants, including the white to black neutral axis. In this example, each color is characterised by a single byte, and therefore the axis are between 0 and 255, with 255 being associated with the maximum amount of a particular colorant for the printing system under consideration (e.g. associated with a maximum weight in nanograms for the printing system). Each circle represents a ‘node’ of the color cube, wherein the node have a predetermined spacing (and in this example, are evenly spaced) along each axis. In this example, there are nine nodes along each axis, and each node of the skeleton is associated with a predetermined corresponding colorimetry, for example via a look up table, wherein the colorimetry in CMY space is determined based on the position of the node (therefore taking a value from the value set [0, 31, 63, 95, 127, 159, 191, 223, 255], as described above. The colorimetry in other color spaces may be determined by modelling, simulation, printing and measuring or the like, as has been set out above.

FIG. 2B shows colorant amounts associated with the white to black neutral axis for the non-black colorants for a CcMmY color set. In this case there is a specified colorant amount maximum threshold expressed in terms of the average total number of ink drops which may be deposited on a single location, which is set at 10 drops. The total colorant usage is shown using the dotted line and it may be noted that the colorant amount approaches the threshold when approaching the darkest achievable colors.

FIG. 2C shows a fully ‘populated’ CMY cube, in which intermediate modes have been added by interpolation (and in some examples, assessed against criteria such as print agent use, grain, robustness and smoothed and/or optimised accordingly).

FIG. 2D shows the colorant use amounts of black ink in coverage vectors lying along a neutral axis being built up using black colorant alone.

In order to generate a lookup table, each vector from the black colorant neutral axis may be combined with at least some of the nodes from FIG. 2C. This can be thought of as replicating the CMY cube with different levels of black. To complete the look-up table, the colorimetry of the newly formed vectors may be determined taking the CMY value of the node from the CMY cube shown in FIG. 2C and the K value from the vector taken from the ‘black colorants’ neutral axis (FIG. 2D). This provides a CMYK to vector mapping, which may form the basis of a mapping resource for converting CMYK input data to print instructions.

By building the CMY cube first, the task of interpolating vectors is relatively constrained (i.e. takes place in three dimensions rather than four dimensions), allowing for efficient use of processing resources. Moreover, by controlling the number of vectors in the second set of vectors (i.e. the number of ‘black levels’), processing resources may be balanced with the number of NPacs stored. It is appropriate to consider the black colorant separately, as the amount of black used may have the greatest impact (when compared to other colorants) on the perceived printed output.

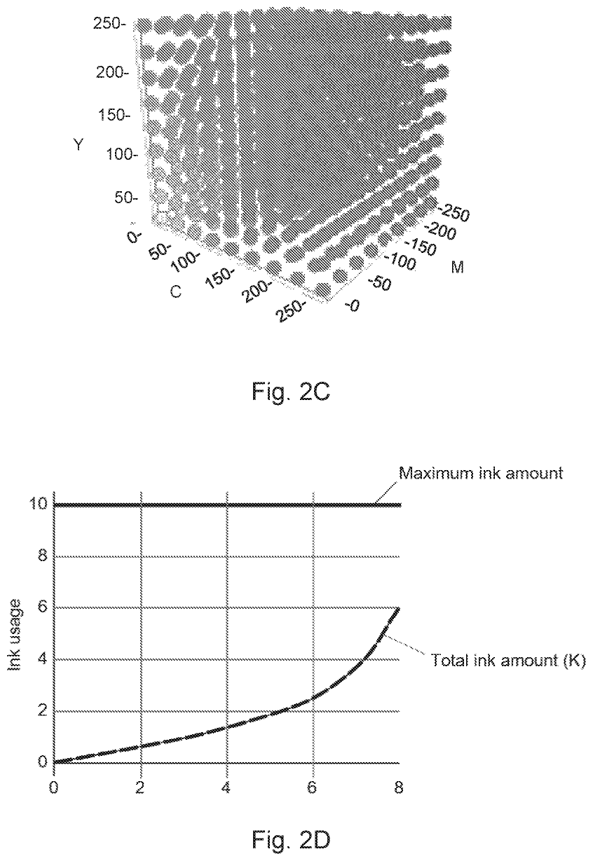

FIG. 3 is an example of a method of combining the non-black and black colorant amounts, i.e. a method of carrying out block 118 of FIG. 1.

In block 302, the colorant amounts are added to form a new print agent vector. In block 304, it is determined whether a print agent amount specified by that print agent vector exceeds a maximum print agent amount (for example, this may be a condition stating that, on average, a vector should not specify more than 10 drops are applied to a single print addressable location). If not, a print agent coverage vector is generated from the print agent vector in block 306. For example, candidate print agent coverage vectors may be generated (for example, randomly or deterministically to match the print agent vector coverages) and evaluated, for example using any or any combination of predetermined rules (for example, rules favouring high or low drop states, rules favouring high or low probabilities associated with blank media and the like), modelling, by simulation and evaluation, by printed and evaluating test patches, or the like.

However, if it is determined in block 304 that the print agent vector exceeds a maximum print agent amount, the print agent amounts specified in the non-black vector may be reduced, for example using the following equation for each colorant:

$$NewColorantAmount = \frac{ColorantAmount}{TotalColorantAmount} \times ( MaxAmount - BlackAmount )$$

A print agent coverage vector is generated from the new print agent vector, having reduced non-black colorant amounts, but preserving the amount(s) of black colorant, in block 306. The black amount may be preserved as a user may be more sensitive to controlling the amount of black colorant printed, in order to produce a particular printed output.

In this example, linear programming processes are used to compute new NPacs that use the same amounts of ink but distribute the NPs in different ways based on varying certain parameters. For example, the parameters could be varied to control the amount of white coverage, promoting colorants being placed side-by-side or promoting overprinting of different colors. The generated NPacs may be assessed, for example by generating actual or simulated test patches, and an NPac selected therefrom by a user or based on an estimate of print quality (for example, an estimate of print agent use, grain, robustness or the like).

FIG. 4 is an example of a method of determining a color mapping resource mapping between CMYK color space and print agent coverage vectors, in this example NPacs.

Block 402 comprises determining a plurality of sets of print agent coverage vectors by combining at least one of the vectors of the third set of print agent coverage vectors with each of the vectors of the second set of vectors, using the methods described above in relation to FIGS. 1, 2 and 3. Assuming that the amounts of CMY are not reduced due to drop thresholds or the like, this in effect generates a plurality of replications of the CMY cube with different added amounts of black colorant, referred to herein as different K-levels.

In some examples, the third set of vectors may be combined with a K amount in the same way for each K-level. However, this need not be the case in all examples. For example, as briefly mentioned above, for higher levels of K (darker colors), this may result in an unnecessarily dense mapping resources as there may be little perceptible difference between the colors of the vectors. Therefore, a different sampling of the third set of vectors may be used for the different K levels, resulting in a different number of combined vectors at different K levels.

Block 404 comprises, for each print agent coverage vector, associating the vector with a CMYK value for that vector. As noted above, this may be determined based on the number of graduations on each of the CMY axes, and the number of graduations on the black colorant neutral axis, and the position along each axis, as has been described above

The resulting mapping resource is a CMYK-indexed look-up table with a plurality of different K levels. There will be a high degree of consistency between corresponding nodes at different K levels, which is obtained through control of the print agent amounts (and not colorimetries). Viewed another way, it may be noted that the vectors at different K levels are not derived by interpolation, which instead is used to compute the full CMY cube.

For example, if the CMYK-to-NPac mapping resource is to have 9 nodes per color channel (axis) there may be 9³ NPacs in the third set of vectors, replicated 9 times with a different level of k-ink s, resulting in 9⁴ NPacs in the final CMYK-to-NPac mapping resource. However, as noted above, different numbers of NPacs may be created for different K-levels.

When compared to, for example, mapping between RGB and NPacs, mapping from CMYK to NPacs provides an explicit control over the amount of black used, which may be of interest to a user.

In this example, in block 406, the second set of print agent coverage vectors (i.e. the black neutral axis vectors) is added to provide the neutral axis of the color mapping resource. While combined print agent coverage vectors (i.e. those including black colorant and non-black colorant) could be used to generate a neutral axis (which may result in reduced grain), using black-only print agent coverage vectors for the neutral axis may reduce ink use, which may be intended in some examples. The option adopted may for example depend on user preference, intended use case or the like.

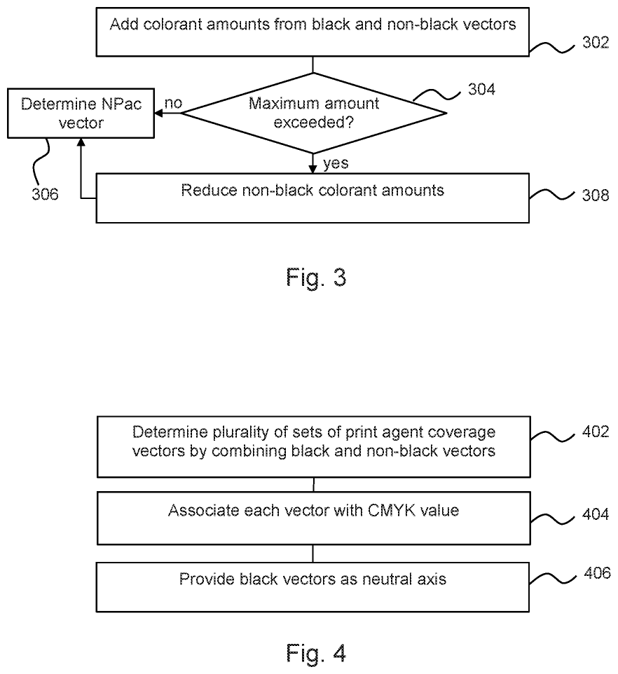

FIG. 5 is an example of processing circuitry 500 comprising a print agent coverage vector module 502, the print agent coverage vector module 502 comprising a vector combining module 504.

In use of the processing circuitry 500, the print agent coverage vector module 502 determines a plurality of print agent coverage vectors for inclusion in a color mapping resource for a print apparatus. The print agent coverage vectors are based on a non-black and black set of vectors. The set of non-black vectors defines an accessible color gamut for non-black colorants of the print apparatus and no black colorants of the print apparatus. The set of non-black vectors may include an achromatic axis of the color gamut. The set of non-black vectors may have any of the attributes of the third set of vectors described above. The set of non-black vectors may comprise vectors interpolated from vectors defining the skeleton of the color gamut, wherein the skeleton may comprise a neutral axis, extremities of the color gamut and/or diagonals of the faces of the color gamut. The number of graduations on each color axis, or channel, for the color gamut may be defined. The color resource may map between a color space having the axes of the colorants, and the vectors. The color mapping resource may for example map between a print agent color space (e.g. CMYK) and print coverage vectors such as NPacs, Mvocs. The set of black vectors defines an achromatic axis of a color gamut for the black colorant of the print apparatus and no non-black colorants of the print apparatus. The set of black vectors may have any of the attributes of the second set of vectors described above.

The vector combining module 504, in use of the processing circuitry 500, combines a plurality of vectors of the set of non-black vectors with a plurality of vectors of the set of black vectors to define a plurality of sets of vectors associated with different amounts of black colorant. For example, this may comprise converting the non-black print agent coverage vectors (e.g. NPacs) into print agent vectors specifying the amounts of non-black colorants but not explicitly stating probabilities associated with their at-pixel combinations, and determining colorant amounts therefrom, then combining the colorant amounts with the black colorant amount from a vector from the set of black vectors (which may also be converted from black NPacs to black print agent vectors), before determining a print agent coverage vector from the combined amounts.

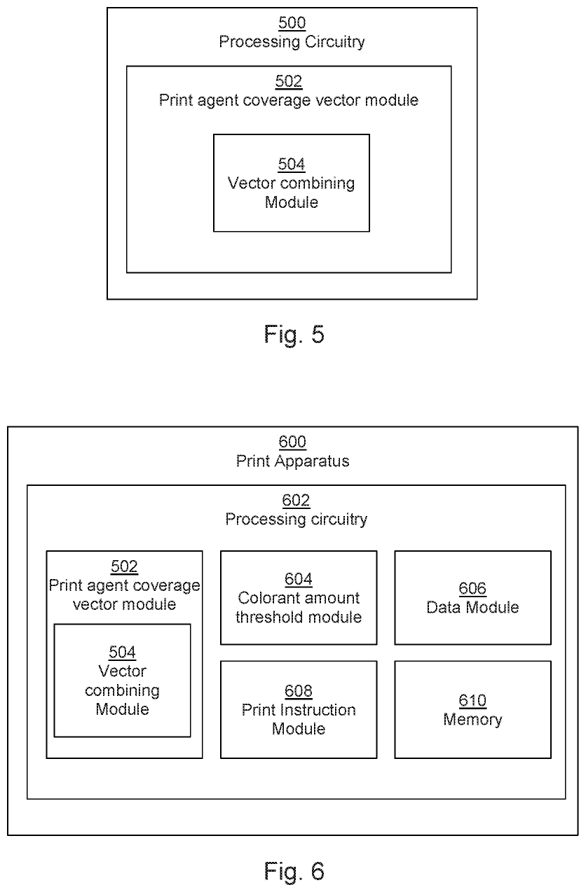

FIG. 6 is an example of print apparatus 600 comprising processing circuitry 602. The processing circuitry 602 comprises, in addition to the print agent coverage vector module 502 comprising a vector combining module 504 described in relation to FIG. 5, a colorant amount threshold module 604, a data module 606 and a print instruction module 608. The print apparatus 600 in this example also comprises a memory 610 to store a generated color mapping resource for the print apparatus 600.

In use of the print apparatus 600, the colorant amount threshold module 604 determines if an amount of colorant in a vector to be generated by the vector combining module 504 exceeds a threshold amount for the print apparatus 600. If so the colorant amount threshold module 604 reduces the amounts of the non-black colorants while maintaining the amount of black colorant, for example as described above with reference to FIG. 3.

In use of the print apparatus 600, the data module 606 acquires data representing an article to be printed. The article may for example comprise a substantially two dimensional image, for example a picture, pattern or text to be applied to a substrate such as paper, card or plastic. In other examples, the article may comprise an object to be printed using additive manufacturing techniques. The instructions may for example include a color description. The color description may be a CMYK color description.

In use of the print apparatus 600, the print instruction module 608 determines print instructions based on the acquired data and using the color mapping resource stored in the memory 610. For example, it may map between a color description and a print agent coverage vector. In some examples, the color mapping resource maps between a CMYK space and the print agent coverage vectors. The actual print agent applied to a print addressable location may be described by an element (e.g. an NP) which may be selected from the vector, for example using halftoning techniques or the like.

The print apparatus 600 may, in use thereof, print an article according to the print instructions. This may be a two dimensional or three dimensional article. To that end, the print apparatus 600 may comprise additional print apparatus components such as a print head, a print agent supply, and the like. Where the print apparatus 600 is a ‘two dimensional’ printer, it may comprise a laser printer or an inkjet printer or the like, and may comprise a print head, substrate handling systems, a source of ink or toner, and the like. Where the print apparatus 600 is a ‘three dimensional’ printer, it may comprise, or be associated with, a print bed, a fabrication chamber, a print head, an energy source, a source of build material, or the like.

In some examples, the processing circuitry 500, 602 may carry out any or any combination of the blocks of FIG. 1, FIG. 3 and/or FIG. 4.

The processing circuitry 500, 602, print agent coverage vector module 502, vector combining module 504, colorant amount threshold module 604, data module 606 and/or the print instruction module 608 may be implemented with one or a plurality of processors executing machine readable instructions stored in a memory, or a processor operating in accordance with instructions embedded in logic circuitry. It is noted that in at least one example described herein, the term “module” refers to a hardware component of the apparatus.

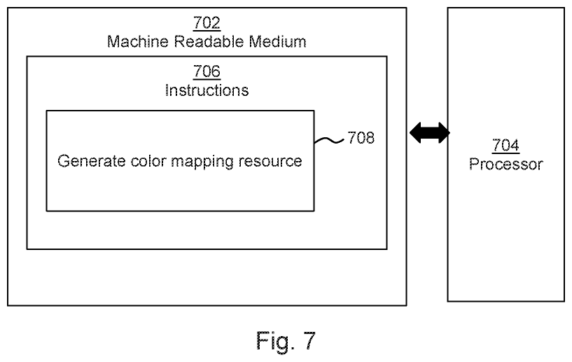

FIG. 7 shows an example of a non-transitory machine-readable medium 702 in association with a processor 704. The machine-readable medium 702 has instructions 706 stored thereon. The instructions 706 when executed by the processor 704 cause the processor 704 to perform processing operations and comprise:

The instructions 706 comprise instructions 708 to cause the processor 704 to generate a color mapping resource by adding colorant amounts from for each of a plurality of print agent coverage vectors characterising a non-black color gamut for a print apparatus, and each of a plurality of predetermined black colorant amounts characterising a neutral axis of the black colorant gamut of the print apparatus. This may comprise determining an amount of each colorant of a vector characterising the non-black color gamut, adding one of the plurality of predetermined black colorant amounts; and deriving a print agent coverage vector from the amounts. The print agent coverage vectors each comprise an element set to be associated with a print addressable location for printing an article, the element set comprising a plurality of elements, wherein each element identifies a print material or print material combination and is associated with a probability that the print material or print material combination identified by that element is to be applied to the associated print addressable location. The elements may comprise up to all the NPs for a given system. The set of vectors or characterising the non-black color gamut may comprise vectors interpolated from vectors defining the skeleton on the color gamut. The skeleton may comprise a neutral axis, extremities of the color gamut, a defined number of nodes for each axis and/or diagonals of the faces of the color gamut. The nodes of the neutral axes may be evenly space in lightness.

In some examples, the instructions 708 may comprise instructions to cause the processor 704 to carry out any or any combination of the blocks of FIG. 1, 3 or 4, and/or to act as any module of the processing circuitry 500, 602.

Examples in the present disclosure can be provided as methods, systems or as a combination of machine readable instructions and processing circuitry. Such machine readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry, or a module thereof, may execute the machine readable instructions. Thus functional modules of the processing circuitry 500, 602 (for example, the print agent coverage vector module 502, vector combining module 504, colorant amount threshold module 604, data module 606 and/or the print instruction module 608) and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
determining, using processing circuitry, a first and second set of print agent coverage vectors characterising a white to black neutral axis in a color space, wherein:
the first set of print agent coverage vectors comprises non-black colorant elements and no black colorant elements, and
the second set of print agent coverage vectors comprises black colorant elements and no non-black colorant elements;
determining, using processing circuitry, print agent coverage vectors characterising a skeleton of a color gamut using the non-black colorants and no black colorants and including the first set of print agent coverage vectors;
determining, using processing circuitry, a third set of print agent coverage vectors from the print agent coverage vectors characterising the skeleton using interpolation;
determining; using processing circuitry, a fourth set of print agent coverage vectors from the third set of print agent coverage vectors by, for each of a plurality of vectors of the third set:
determining an amount of each non-black colorant specified in the vector of the third set of print agent coverage vectors,
determining an amount of black colorant from one of the vectors from the second set of print agent coverage vectors; and
determining a vector of the fourth set of print agent coverage vectors based on the amounts of non-black and black colorants.

2. A method according to claim 1 further comprising determining, using processing circuitry, at least one further set of print agent coverage vectors by repeating the process for determining the fourth set of vectors with at least one other of the vectors of the second set of print agent coverage vectors.

3. A method according to claim 1 further comprising determining, using processing circuitry, if a combined amount of black and non-black colorant exceeds a threshold and, when the amount of black and non-black colorant exceeds a threshold, reducing the non-black colorant amounts to determine the vector of the fourth set of vectors.

4. A method according to claim 1 further comprising determining, using processing circuitry, the vector of the fourth set of print agent coverage vectors by:
adding the amounts of non-black colorant and black colorant; and
deriving a print agent coverage vector from the amounts, the print agent coverage vector comprising an element set to be associated with a print addressable location for printing an article, the element set comprising a plurality of elements, wherein each element identifies a print material or print material combination and is associated with a probability that the print material or print material combination identified by that element is to be applied to the associated print addressable location.

5. A method according to claim 4, wherein deriving the vector of the fourth set of vectors comprises determining the vector using linear programming.

6. A method according to claim 1, comprising determining, using processing circuitry, a color mapping resource comprising the third and fourth sets of print agent coverage vectors and, for each vector, a corresponding colorimetry based on the amount of each colorant.

7. A method according to claim 6 wherein determining the color mapping resource comprises including the second set of print agent coverage vectors to provide the white to black neutral axis of the color mapping resource.

8. A method according to claim 1, wherein the color gamut for the non-black colorants is an accessible color gamut for a predetermined print apparatus using the non-black colorants, and comprises a CMY color cube having a predetermined node spacing.

9. A method according to claim 1 wherein the print agent coverage vectors comprise element sets to be associated with a print addressable location for printing an article, each element set comprising a plurality of elements, wherein each element identifies a print material, print material combination or an absence of print material; and is associated with a probability that the print material or print material combination identified by an element is to be applied, or that no print material is applied; to the associated print addressable location.

10. Processing circuitry comprising:
a print agent coverage vector module to determine a plurality of print agent coverage vectors for inclusion in a color mapping resource for a print system based on:
a set of non-black vectors defining a color gamut for non-black colorants of the print apparatus and no black colorants of the print apparatus; and
a set of black vectors defining an achromatic axis of a color gamut for the black colorant of the print apparatus and no non-black colorants of the print apparatus,
wherein the print agent coverage vector module comprises a vector combining module to combine a plurality of vectors of the set of non-black vectors with a plurality of vectors of the set of black vectors to define a plurality of sets of vectors associated with different amounts of black colorant.

11. Processing circuitry according to claim 10 further comprising a colorant amount threshold module to determine if an amount of colorant in a vector to be generated by the vector combining module exceeds a threshold amount for the print system and, if so, to reduce an amount of non-black colorants while maintaining an amount of black colorant.

12. Processing circuitry according to claim 10 wherein the vector combining module:
determines an amount of each non-black colorant specified in the vector of the set of non-black vectors,
determines an amount of black colorant from one of the vectors from the set of black vectors; and
determines a combined vector by adding the amounts of non-black and black colorants and converting the amounts to a print agent coverage vector using linear programming.

13. Processing circuitry according to claim 10 further comprising a data module to acquire data representing an article to be printed and a print instruction module to determine print instructions based on the acquired data and using the color mapping resource.

14. Processing circuitry according to claim 13 further comprising print apparatus to print an article according to the print instructions.

15. A machine readable medium comprising instructions which, when executed by a processor, cause the processor to:
generate a color mapping resource by:
for each of a plurality of print agent coverage vectors characterising a non-black color gamut for a print apparatus, and each of a plurality of predetermined black colorant amounts characterising a neutral axis of a black colorant gamut of the print apparatus:
determining an amount of each colorant in a vector characterising the non-black color gamut;
adding one of the plurality of predetermined black colorant amounts; and
deriving a print agent coverage vector from the amounts,
wherein the print agent coverage vectors each comprise an element set to be associated with a print addressable location for printing an article, the element set comprising a plurality of elements, wherein each element identifies a print material or print material combination and is associated with a probability that the print material or print material combination identified by that element is to be applied to the associated print addressable location.
